(19) United States
(12) Patent Application Publication
(10) Pub. No.: US 2011/0208572 A1
(43) Pub. Date: Aug. 25, 2011

(54) SYSTEMS AND METHODS FOR PROVIDING A REFFERAL REWARD INCENTIVE FOR AN ITEM VIA A NETWORKING WEBSITE

(75) Inventors: Gregory Richard Ladd, Elkhorn, NE (US); Gerald Richard Ladd, Omaha, NE (US)

(73) Assignee: ASC Information Technology, Inc., Omaha, NE (US)

(21) Appl. No.: 12/710,175

(22) Filed: Feb. 22, 2010

(51) Int. Cl. G06Q 30/00; G06Q 99/00

(52) U.S. Cl. 705/14.16

(57) ABSTRACT

A computer-implemented method for providing a referral reward incentive via a networking website is described. Registration information for an item that is associated with a reward may be received. Information relating to an item purchased by a first subscriber of the networking website may be displayed. A recommendation for the purchased item may be posted from the first subscriber to a second subscriber of the networking website. The reward may be distributed to the first subscriber if the second subscriber purchases the item based on the recommendation received from the first subscriber.

### BACKGROUND

The use of computer systems and computer-related technologies continues to increase at a rapid pace. This increased use of computer systems has influenced the advances made to computer-related technologies. Indeed, computer systems have increasingly become an integral part of the business world and the activities of individual consumers. Computer systems may be used to carry out several business, industry, and academic endeavors. The wide-spread a use of computers has been accelerated by the increased use of computer networks, including the Internet. Many businesses use one or more computer networks to communicate and share data between the various computers connected to the networks. The productivity and efficiency of employees often requires human and computer interaction.

Users of computer technologies continue to demand that the efficiency of these technologies increase. For instance, users demand improvements in the functionality of computing devices. For example, computing technologies may generate various marketing and advertising reports for suppliers of goods and services. These suppliers demand that the capabilities of computer systems improve in order to improve the information within these marketing reports.

In addition, suppliers often reward consumers for their loyalty and referrals to other consumers. Suppliers also demand that the capabilities of computer systems improve so as to improve the efficiency and effectiveness of these loyalty based incentives. Networking websites have become a popular means for computer users to share information and stay in touch. As a result, benefits may be realized by providing systems and methods for providing a referral reward incentive via a networking website.

### SUMMARY

A computer-implemented method for providing a referral reward incentive via a networking website is described. Registration information for an item that is associated with a reward may be received. Information relating to an item purchased by a first subscriber of the networking website may be displayed. A recommendation for the purchased item may be posted from the first subscriber to a second subscriber of the networking website. The reward may be distributed to the first subscriber if the second subscriber purchases the item based on the recommendation received from the first subscriber.

In one embodiment, a confirmation may be made as to whether the purchase of the item by the first subscriber is a qualified purchase. In addition, a verification may be made as to whether the first subscriber received a recommendation for the item prior to the purchase of the item. In one configuration, the distribution of the reward may be prevented if the first subscriber received a recommendation for the item prior to the purchase of the item.

In one example, login credentials of the first subscriber and the second subscriber may be validated for the networking website. A first user profile may be generated for the first subscriber and a second user profile may be generated for the second subscriber. A confirmation may be made as to whether the first user profile and the second user profile are linked together on the networking website.

In one configuration, a first portion of the reward may be distributed to the first subscriber and a second portion of the reward may be distributed to a third subscriber. The third subscriber may be an assignee of a portion of the reward.

In one example, a recommendation for the purchased item may be posted on a web page of the networking website. In one embodiment, the web page is assigned to the second user.

A computer system configured to provide a referral reward incentive via a networking website is also described. The system may include a processor and memory in electronic communication with the processor. The system may further include a registration module configured to receive registration information for an item that is associated with a reward, and a purchase field configured to display information relating to an item purchased by a first subscriber of the networking website. The system may also include a recommendation field configured to post a recommendation for the purchased item from the first subscriber to a second subscriber of the networking website, and a distribution module configured to distribute the reward to the first subscriber if the second subscriber purchases the item based on the recommendation received from the first subscriber.

A computer-program product for providing a referral reward incentive via a networking website is also described. The computer-program product includes a computer-readable medium having instructions thereon. The instructions include code programmed to receive registration information for an item that is associated with a reward, and code programmed to display information relating to an item purchased by a first subscriber of the networking website. The instructions further include code programmed to post a recommendation for the purchased item from the first subscriber to a second subscriber of the networking website, and code programmed to distribute the reward to the first subscriber if the second subscriber purchases the item based on the recommendation received from the first subscriber.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of a environment in which the present systems and methods may be implemented;

FIG. 2 is a block diagram illustrating an embodiment of a website in accordance with the present systems and methods;

FIG. 3 is a block diagram illustrating a further embodiment of a website;

FIG. 4 is a flow diagram illustrating one embodiment of a method for registering a vendor and items provided by the vendor;

FIG. 5 is a flow diagram illustrating one embodiment of a method for distributing a bounty associated with an item to a purchaser of the item;

FIG. 6 is a flow diagram illustrating one embodiment of a method for qualifying the purchase of an item as a qualified purchase;

FIG. 7 is a flow diagram illustrating one embodiment of a method for distributing a bounty associated with an item to an initial subscriber;

FIG. 8 depicts a block diagram of a computer system suitable for implementing the present systems and methods; and

FIG. 9 is a block diagram depicting a network architecture in which client systems, as well as storage servers (any of which can be implemented using computer system), are coupled to a network.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The Internet has provided numerous ways for people to network with other people. For example, there are a variety of social networking websites on the Internet that allow a user of these sites to build networks and relations with other users of these sites that share the same interests, activities, beliefs, and the like. For example, a user may be “linked” to other users that share these common interests. The other users are commonly referred to as friends, contacts, associates, etc. A social networking website typically includes a representation of each user (often referred to as a profile), social web links of interest to the user, photos selected by the user, and a variety of other services. A user of a social networking website may be provided with one or more personal web pages. These web pages may include various information about the user such as a list of his/her contacts, photos, interests, activities, photos, messages from the user or his/her contacts, and the like.

Many social networking websites provide means for users to interact with each other through email and instant messaging services. Some examples of these networking websites may include MySpace.com, Facebook.com, Twitter.com, LinkedIn.com, and the like. Revenue from these websites may be generated via subscriptions paid by the users of the website. In addition, the websites may generate revenue by providing space on the website for online advertising. If a networking website satisfies the needs of a user, he/she may become loyal user of that particular website. As the number of loyal users of a website increase, the number of subscriptions and fees for online advertising may also increase. As a result, the revenue generated by the website also increases.

Apart from social networking websites, the marketplace has provided loyalty programs for consumers. These programs may include offering rewards to consumers for certain actions (e.g., purchasing a particular item, providing a referral, and the like). The rewards may be instantaneous (e.g., monetary reward, points that may have monetary value, etc.), a discount on a current or future purchase, or periodic rewards. For example, a supplier of a particular item may reward a consumer that purchases a certain quantity of the item over a particular time period. Loyalty programs, however, do not exist in connection with social networking websites or affiliations that distribute bounties (i.e., rewards) for certain actions performed by the user of the website. These actions may include purchasing an item, promoting a item, personally recommending an item to others, and the like.

In one-embodiment, the present systems and methods combine loyalty programs with social networking websites. A benefit of the present system and methods may include creating revenue for vendors that is tied to actual product sales. The combination of a loyalty program with a networking website combines the power of word-of-mouth advertising with the phenomena of social networking websites to create revenue for vendors at a minimal cost that may replace both advertising dollars and money spent on purchasing or preparing demographic information regarding purchases of certain items. Instead of general advertising that may produce no direct revenue, the present systems and methods may allow vendors to know exactly what revenue is going to be generated for each dollar spent.

The present systems and methods may also improve the current method of generating revenue through celebrity endorsements and celebrity advertising of a particular item, brand, etc. Typically, vendors pay a celebrity (i.e., public figure) to endorse a certain item, brand, etc. with a hope of resulting sales from said endorsement. The present systems and methods allow a vendor to contract with celebrities to purchase items that are linked to a reward and then recommend the items to all of the celebrities' friends, contacts, associates, followers, etc. that are linked to the celebrity on a social networking website. The reward may be some type of benefit (e.g., monetary payment) that is distributed from the vendor to the celebrity when the recommended item is purchased by one of the celebrities' friends on the networking website. As a result, the provider of the networking website may pay the celebrity for actual sales of the item, and not simply an endorsement of the item that may not result in any sales.

The present systems and methods may also provide a means for consumers of items to create revenue. For example, a person may purchase an item that is linked to a reward, and then recommend the item to his/her friends, contacts, associates, etc. on a social networking website. The reward may be distributed to the original purchaser when one or more of his/her friends on the social networking website purchase the recommended item.

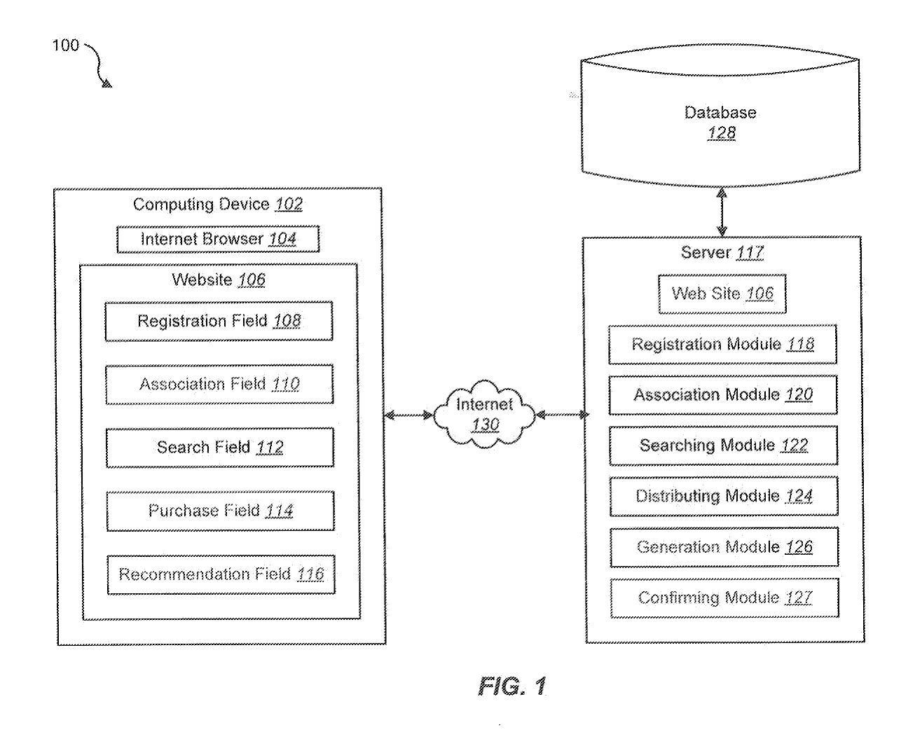

FIG. 1 is a block diagram illustrating one embodiment of a environment 100 in which the present systems and methods may be implemented. In one configuration, a computing device 102 may communicate with a server 117 across a network connection 130, such as the Internet.

The computing device 102 may be a personal computer, a laptop, a personal digital assistant (PDA), a smartphone, or any other type of computing device. In one example, the computing device 102 may include an internet browser 104. The browser 104 may be an application or program installed on the computing device 102 to display information hosted by the server 117. For example, the internet browser 104 may display a website 106 on the computing device 102. The website 106 may be hosted or stored on the server 117. The internet browser 104 may access the website 106 across the Internet 130.

In one embodiment, the website 106 may be a social networking website as described above. The website 106 may include multiple fields or areas to gather and display information to a user. In one example, the website 106 may include a registration field 108. The registration field 108 may be a space or area in which a user may provide information in order to access additional information on the website 106. For example, the user may provide registration information in the registration field 108 if the user is not currently subscribed to the website 106. Similarly, the user may provide login information in the registration field 108 if the user is already registered as a subscriber of the website 106. For example, the user may provide a username and password in the registration field 108 if the user is already subscribed to the website 106.

In one configuration, a database 128 may store information regarding registered users (i.e., subscribers) of the website 106. For example, the database 128 may store the username and password of a user that is a subscriber to the website 106. The server 117 may communicate with the database 128 to provide data to the database 128, retrieve data from the database 128, or analyze data stored in the database 128. In one embodiment, a registration module 118 may analyze information provided in the registration field 108. The registration module 118 may compare the information in the field 108 with information stored within the database 128. For example, the module 118 may compare a username and password provided in the registration field 108 with usernames and passwords stored in the database 128. Based on this comparison, the registration module 118 may determine whether a user has properly signed in (or logged in) to the website 106. Once the user has properly signed in or subscribed to the website 106, the user may have access to various content provided on the website 106. In one configuration, the various content on the website 106 may be open to the public and it may not be necessary for a user to provide registration information in the registration field 108.

The website 106 may also include an association field 110. A user may enter information into the association filed 110 about other users of the website 106. An association module 120 may analyze the information provided in the association field 110. The association module 120 may then search the database 128 for information regarding the additional users whose information has been entered into the association field 110. The association module 120 may then associate (or link) the additional users with the user that entered the information into the association field 110. For example, a user may enter the name or other information about another user that is subscribed to the website 106. The user may desire to be linked to the other user in order to network with the other user via the website 106.

In one configuration, the website 106 may further include a search field 112. A user may search for additional users that share common interests, hobbies, careers, etc. Further, vendors may register items, such as products and services, on the website 106. Information regarding these registered items may be stored in the database 128. For example, a description of the item, the price of the item, and information regarding a reward linked to the item may be stored in the database 128. A user may search for these items by entering information about a particular item in the search field 112. In one embodiment, a searching module 122 may access the database 128 to locate information regarding additional users, products, or services entered into the search field 112.

In one example, the website 106 may also include a purchase field 114. The purchase field 114 may display one or more registered items that have been purchased by a user of the website 106. The recommendation field 116 may display recommendations for a particular product or service purchased by a user of the website 106.

In one embodiment, the server 117 may further include a distributing module 124. The module 124 may distribute a reward, a bounty, or other benefit linked to a particular item to a user that has satisfied certain requirements to qualify for the distribution. A confirming module 127 may confirm whether or not the user has satisfied the requirements for receiving the reward associated with a particular item. The server 117 may further include a generation module 126. The module 126 may generate various reports or other information requested by a user or vendor subscribed to the website 106.

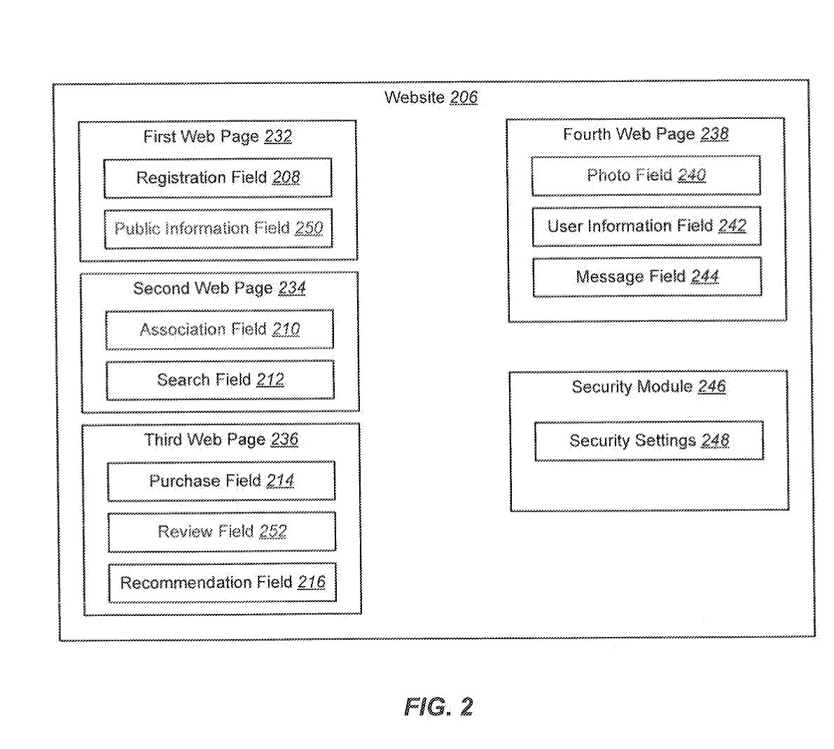

FIG. 2 is a block diagram illustrating a further embodiment of a website 206 in accordance with the present systems and methods. In one configuration, the website 206 may be a social networking website. The website 206 may include multiple web pages 232, 234, 236, 238. While only four web pages are illustrated, it is to be understood that more or less web pages may be included on the website 206.

In one example, a first web page 232 may include a registration field 208 and a public information field 250. A user may enter registration information into the registration field 208 in order to gain access to additional web pages within the website 206. For example, a user may enter a username and password in the registration field 208. In addition, a user may create an account by entering information into the registration field 208. The generation module 126 may create a user profile when the user registers with the website 206.

In one embodiment, the public information field 250 may display information for all visitors to the website 206, regardless if the visitor is a subscriber to the website 206. In other words, a visitor may view information in the public information field 250 even if the visitor has not signed in to the website 206 by providing a username and password in the registration field 208. In one example, the public information field 250 may include information about items, such as products or services, offered by various vendors, and a bounty or reward linked to these items.

The website 206 may also include a second web page 234. In one embodiment, the second web page 234, the third web page 236, the fourth web page 238, and any additional web pages may only be accessed by a subscriber to the web site 206. In other words, a registered user that successfully provides sign in or login information on the first web page 232 may access all the additional web pages 234, 236, 238, or a portion of the additional web pages 234, 236, 238. In one configuration, each subscriber to the website 106 may have one or more web pages 232, 234, 236, 238 that are assigned to that particular subscriber.

The second web page 234 may include an association field 210 and a search field 212. A user may enter information about another user in the association field 210. For example, a first user may desire to be linked to a second user. The first user may enter information regarding the second user in the association field 210. Information about the second user entered by the first user may include an email address of the second user, the name of the second user, an identifier that identifies the second user (e.g., username of the second user), and the like. When the first user is linked to the second user, the users may receive updates and messages from each other. The connected users may also be able to access or view information posted on each others web pages (e.g., photos, documents, etc.), and the like. Users that are linked together may be referred to as friends, contacts, associates, etc.

In addition, a user may enter information about a particular vendor or item in the association field 210. For example, if a user desires to follow a particular company or a particular product, the user may enter information regarding the company or the product in the association field 210. The user may then receive updates or other information regarding the company or the product.

In one embodiment, the second web page 234 may further include a search field 212. A user may enter search terms for another user, vendor, item, etc. For example, a first user may desire to be linked to other users that share the same interests as the first user. The first user, however, may not know the email address, the name, or other identifier for these other users. As a result, the first user may enter information regarding an interest, hobby, or other information into the search field 212 in an attempt to locate profiles of other users.

Similarly, a user may enter information regarding a company or a product in the search field 212. For example, a user may desire to locate companies that produce a certain product or provide a particular service. The user may enter information regarding the type of product or service into the search field 212 in order to locate information regarding companies that provide the produce or service.

In one embodiment, the website 206 may include a third web page 236. The third web page 236 may include a purchase field 214, a review field 252, and a recommendation field 216. The purchase field 214 may include a list of items, such as products or services, purchased by a user. The review field 252 may include comments or other reviews regarding items purchased by the user that may be listed in the purchase field 214. Other users may view these reviews in the review field 252 when they are deciding whether or not to purchase a particular item. In addition, other users may post comments to the reviews listed in the review field 252. The recommendation field 216 may include a list of items that have been recommended to the user by another user. In addition, the recommendation field 216 may include a list of items that a user has recommended to other users. In one configuration, users may be required to be linked to a user as an associate, friend, contact, etc. in order to view the items listed in the purchase field 214, the reviews listed in the review field 252, and the recommendations in the recommendation field 216. In another configuration, the information provided in the fields 214, 252, 216 may be available to all users of the website 106, regardless if a user is linked to the user that posted the information in the fields 214, 252, 216.

The website 206 may include a fourth web page 238. The fourth web page 238 may include a photo field 240, a user information field 242, and a message field 244. As previously explained, the website 206 may be a social networking website. As a result, a first user may be allowed to upload pictures in the photo field 240, as well as information about himself/herself in the user information field 242. Additional users that are linked to the first user may be able to view the information in the photo field 240 and the user information field 242. In addition, users that are linked together may contact each other via email, instant messaging, text messages, and the like via the website 206. The message field 244 may display messages received and sent between users that are linked together. Messages may inform a first user when a second user (with whom the first user is linked) modifies portions of his/her web pages, makes a purchase of a particular item, and the like. In another embodiment, users that are not linked to the first user may be able to view information posted in the photo field 240, the user information field 242, and the message field 244.

The website 106 may further include a security module 246. The security module 246 may include security settings 248 that may be modified by a user. The security settings 248 may allow the user to either restrict or allow unlimited access to the various web pages 232, 234, 234, 238 of the user by other users. For example, a user may set the security settings 248 so that only users that are associated or linked to the user may be able to view the information provided in the various web pages. In contrast, the user may set the security settings 248 so that all users (linked or not linked to the user) of the website 206 may view the information within the web pages 232, 234, 236, 238 of the user. Further, the user may set the settings 248 so that only certain web pages are accessible to associated and non-associated users.

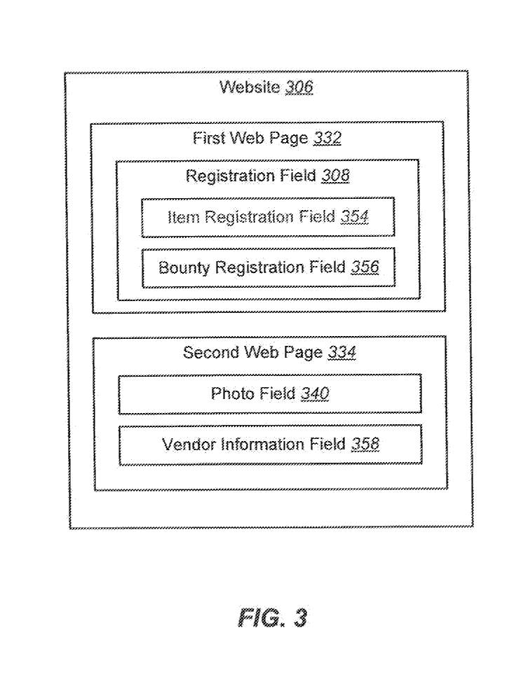

FIG. 3 is a block diagram illustrating a further embodiment of a website 306 with various web pages 332, 334 that may be assigned to a vendor or supplier of various products and services. In one embodiment, the website 306 may be a social networking website as described above. The first web page 332 may include a registration field 308 that may allow a vendor to register or create an account with the website 306 in a manner similar to that described above.

In addition, the registration field 308 may include an item registration field 354 and a bounty registration field 356. A vendor may register a particular item by providing information about the item in the item registration field 354. This information may include the name of the item, specifications about the item, the price of the item, and the like. The vendor may also associate a particular bounty or reward with the item by providing bounty information in the bounty registration field 356. The bounty information may include a monetary value that may be associated with a particular item. In other words, the registered item may be linked with the registered bounty. A bounty may be a reward that is distributed to a consumer when a consumer satisfies certain conditions associated with the bounty.

The website 306 may also include a second web page 334. The second web page 334 may include a photo field 340 and a vendor information field 358. The photo field 340 may include photos or other descriptive information regarding an item that has been registered on the website 306. In addition the photo field 340 may include photos relating to the vendor (e.g., picture of company headquarters, management, etc.). The vendor information field 358 may display information regarding the vendor such as the vendor's name, address, type of business items provided by the vendor, and the like.

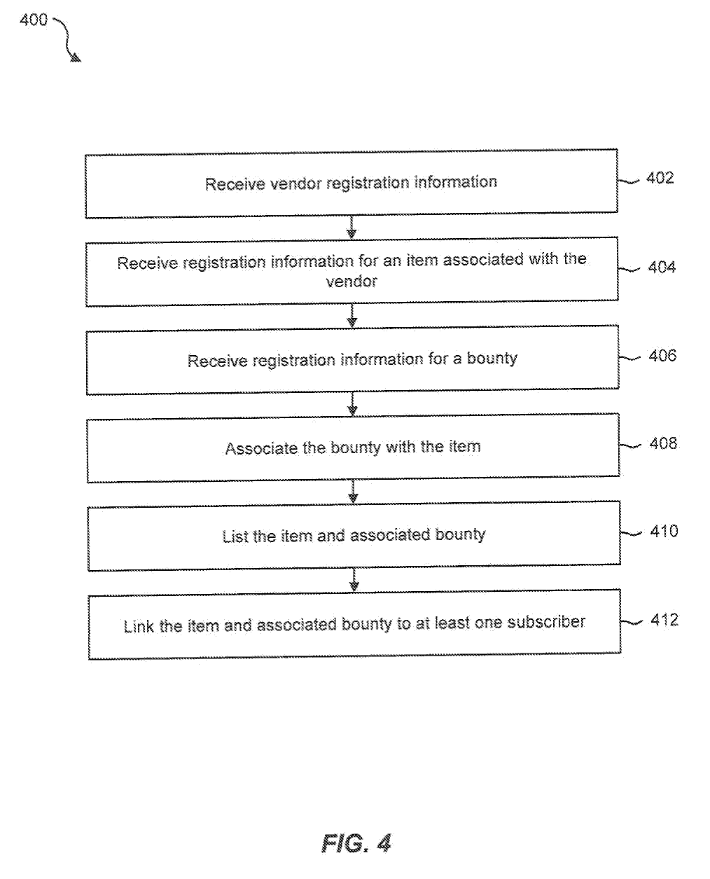

FIG. 4 is a flow diagram illustrating one embodiment of a method 400 for registering a vendor and items provided by the vendor with a social networking website 106. In one embodiment, a vendor may include a manufacturer, a service provider, a retailer, a wholesaler, a financial service provide, a distributor, and any other person or entity that desires to increase sales of a particular product or service.

In one configuration, vendor registration information may be received 402 on the website 106. The vendor registration information may include information relating to the vendor. The information may be used to form a contract between the vendor and a provider or owner of the social networking website 106. In addition, registration information for an item provided by the vendor may also be received 404 on the website 106. The item may be a product or service provided by the vendor. The registration information for the item may include a description of the item, the price of the item, photos of the item, and the like. In one configuration, registration information for a bounty may also be received 406 on the website. The registration information for the bounty may include the amount of the bounty, the total amount of bounty to be issued, the time period bounties will be issued, the amount of the bounty or flat fee amount that will be distributed to the owner (or provider) of the website 106, and the like. The bounty may then be associated 408 or linked with the item. In one embodiment, the item and the associated bounty may then be listed 410 on a web page of the website. In one embodiment, the item and the associated bounty may be listed 410 in a searchable format on a web page of the website that may be accessed by subscribers to the website. In another embodiment, non-subscribers to the website 106 may also access the web page that lists registered items and their associated bounties.

In one embodiment, the item and the associated bounty may be linked 412 to at least one subscriber of the website. In one configuration, the item and the associated bounty may be linked to a particular subscriber of the website based on information gathered from the subscriber when the subscriber registered with the website 106. For example, the item and associated bounty may be linked 412 to a first subscriber based on the first subscriber's purchasing history, referral history, and the like. A message may be sent to a web page of the first subscriber informing him/her of the registered item. The item may also be linked to other subscribers in addition to the first subscriber. In one embodiment, the item and associated bounty may be linked 412 to some or all of the subscribers that are associated with the first subscriber. For example, the item may be linked to the associated subscribes that have similar purchasing histories, referral histories, recommendation histories, and the like as the first subscriber.

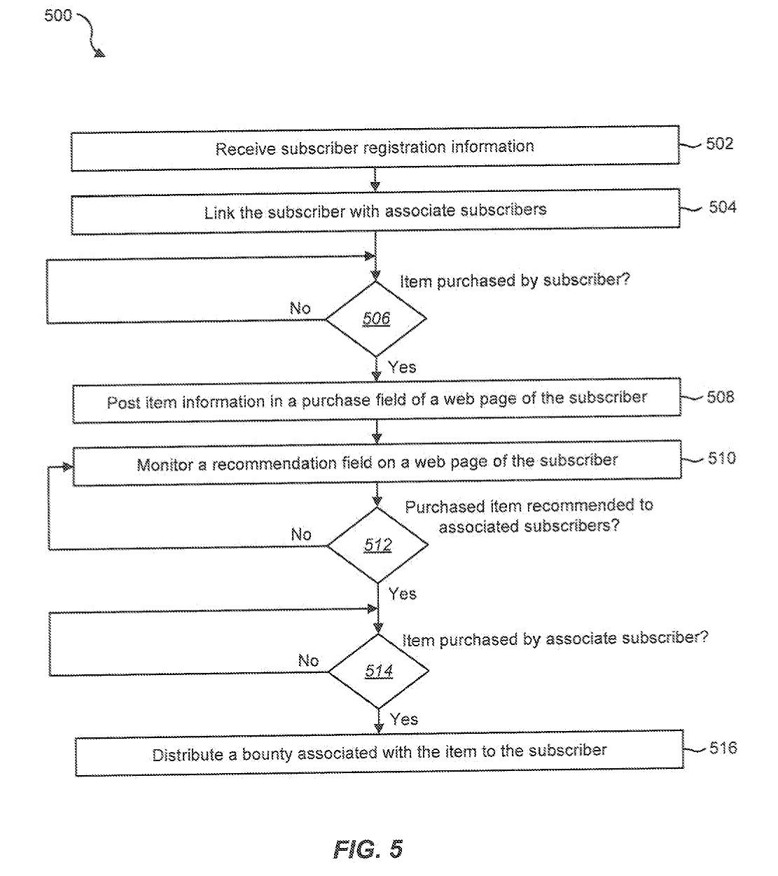

FIG. 5 is a flow diagram illustrating one embodiment of a method 500 for distributing a bounty associated with an item to a purchaser of the item. In one embodiment, the method 500 may be implemented by the website 106 and various modules associated with the website 106.

In one configuration, subscriber registration information may be received 502. As previously explained, the subscriber registration information may be used-to register a user with the website 106 or allow a user that has already registered with the website 106 (e.g., a subscriber) to login to the website 106. If a user is registering with the website 106, the registration information may include hobbies, jobs, family status, purchasing history, products used, and similar information. When the user has successfully registered with the website 106, he/she will be provided with (or create) a username and password or some other credentials that will allow the user to sign in or login to the website 106. In one embodiment, when a subscriber initially logs on to the website 106, the subscriber may be linked 504 with other subscribers. These other subscribers may be referred to as associate subscribers.

As previously explained, a search field 112 may be available on publicly accessible web pages of the website 106 to allow subscribers to search for other subscribers. Various types of information may be entered into the search field 112 to search for other subscribers. This information may include, but is not limited to, email addresses, schools attended, jobs, hobbies, and the like. Additionally, a subscriber may search for other subscribers that have similar qualified purchases. The association module 120 may compare subscribers' qualified purchasing habits and other information collected about the purchaser to compare how alike two subscribers may be to each other. The searching module 122 may filter the results of the comparison provided by the association module 120.

In one embodiment, any subscriber may request to associate with another subscriber. Once a subscriber (“first subscriber”) determines that he/she wants to associate with another subscriber (“second subscriber”) there are several ways to establish the association or link between the first subscriber and the second subscriber. In one embodiment, the first subscriber may click a link from a web page of the first subscriber and enter the second subscriber's user name. In another embodiment, the first subscriber may click a link from a web page assigned to the second subscriber. In yet another embodiment, the first subscriber may click an associate link provided in a search results list by the second subscriber's name.

Upon clicking the appropriate link, the second subscriber may receive an association request message. The message may appear on a portion of a web page assigned to the second subscriber. Based upon the registration details and preferences of the first subscriber, the message may also be sent to the second subscriber by other communications means. For example, an email, instant message, text message, etc. may be sent to the second subscriber that includes the association request message from the first subscriber.

In order to finalize the association, the second subscriber may click in a certain area of a web page assigned to the second subscriber in order to accept the association request. Upon acceptance, the two subscribers may be associated or linked. A part of some or all of the web pages assigned to the various subscribers may include a list that displays each of the subscriber's associated subscribers. In one embodiment, the first subscriber may terminate the association with the second subscriber at any time. The first subscriber may click on a termination link next to the second subscriber's name or other identifier that appears on a list of associated subscribers for the first subscriber. The second subscriber may likewise terminate the association with the first subscriber in the same manner previously described.

Once the first subscriber has logged into the website 106, a determination 506 may be made as to whether an item is purchased by the first subscriber. The item may have been previously registered on the website 106 by a vendor or supplier of the item. The first subscriber may become aware of the registered item via web pages on the website 106. In addition, the first subscriber may become aware of the item via an email, text message, instant message, or other communications means generated by the website 106.

If it is determined 506 that an item is not purchased by the first subscriber, the method 500 may continue to monitor and determine when an item is purchased by the first subscriber. If it is determined 506 that an item is purchased by the first subscriber, item information may be posted 508 in a purchase field of a web page assigned to the first subscriber.

In one embodiment, a recommendation field on a web page assigned to the first subscriber may be monitored 510. A determination 512 may then be made as to whether the purchased item is recommended by the first subscriber to an associate subscriber (such as the second subscriber). If it is determined 512 that the purchased item is not recommended to an associate subscriber, the method 500 may continue to monitor 510 the recommendation field on the web page assigned to the first subscriber. If, however, it is determined 512 that the purchased item is recommended to an associate subscriber, a determination 514 may be made as to whether the item is purchased by an associate subscriber. If it is determined 514 that an item has not been purchased by an associate subscriber, the method 500 may continue to monitor in order to determine 514 when an item is purchased by an associate subscriber. If, however, it is determined 514 that a recommended item is purchased by an associate subscriber, a bounty associated with the item may be distributed 516 to the first subscriber that recommended the item to the associate subscriber.

The bounty may be distributed by depositing a monetary value in an account (such as a bank account or other online account) of the first subscriber. In one embodiment, distribution of the bounty associated with the item may require that the first subscriber purchase the item, recommend the item to associate subscribers, and at least one associate subscriber purchase the item as a result of the recommendation.

In addition, to posting purchases and recommendations on a personal web page of the first subscriber, the first subscriber may communicate purchases of items and recommendations of the items to a second subscriber via email, text messages, instant messaging, or some other communications medium. The messages regarding purchases and recommendations of items may be generated by the generation module 126. In one embodiment, the website 106 may also include electronic links to personal computers emails in order to allow recommendation emails for items to be sent to associate subscribers. Additionally, email, text messages, instant messages, and chats may be generated from within the website 106. Applications for mobile devices may also generate recommendations remotely to be sent to associate subscribers.

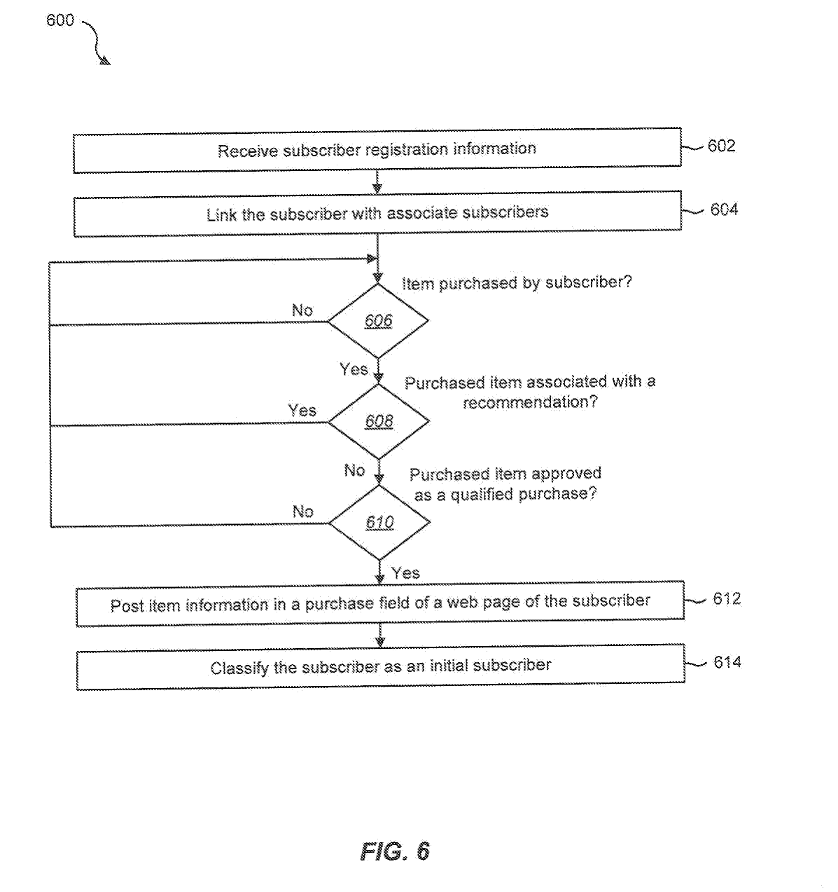

FIG. 6 is a flow diagram illustrating one embodiment of a method 600 for qualifying a purchase of an item as a qualified purchase. The method 600 may be implemented by the website 106 and the various modules associated with the website 106. In particular, the method 600 may be implemented by the confirming module 127. In one embodiment, an initial subscriber may refer to a subscriber that purchases an item without the item being recommended by another subscriber. An associate subscriber may refer to a subscriber that receives a recommendation (from an initial subscriber) for an item that has been purchased by the initial subscriber.

In one configuration, subscriber registration information may be received 602 to allow a subscriber to access the website 106 as described above. The subscriber may be linked 604 with associate subscribers. In one embodiment, this step may be optional as the subscriber may already have been linked or associated with other subscribers.

A determination 606 may be made as to whether an item is purchased by the subscriber. If it, is determined 606 that an item is purchased by the subscriber, a determination 608 may then be made as to whether the purchased item is associated with a recommendation. If it is determined 608 that the purchase item is associated with a recommendation, the method 600 may return to determine whether a different item has been purchased by the subscriber. If, however, it is determined 608 that the purchased item is not associated with a recommendation, a determination 610 may then be made as to whether the purchased item is approved as a qualified purchase. If it is determined 610 that the purchase item is not approved as a qualified purchase, the method 600 may return to determine 606 whether a different item has been purchased by the subscriber. If, however, it is determined that the purchased item is approved as a qualified purchase, item information may be posted 612 in a purchase field of a web page of the subscriber. In addition, the subscriber may be classified 614 as an initial subscriber.

In one embodiment, in order for a purchase of an item to be qualified, confirmation must be made that the purchase was in fact made by the initial subscriber. The confirmation options may include, but are not limited to, purchasing the item via a web store provided by the website 106 by the initial subscriber. In addition, the purchase may be a qualified purchase if it is made by the initial subscriber with a credit card, debit card, or gift card that has been registered by the initial subscriber when logged in the website 106. Further, the purchase may be a qualified purchase if the purchase is made at a store with software and hardware capabilities of scanning a loyalty card that has been generated by the website 106 and is linked to the initial subscriber. In addition, the initial subscriber may take a picture of the item, the packaging bar code, and the receipt. The picture(s) may then be uploaded to the website 106. In one embodiment, this information may be uploaded remotely from a mobile device, such as, but not limited to, a cell-phone, a smartphone, a FDA device, and the like. The evidence (or proof) used to confirm that a purchase is a qualified purchase may be linked to the registered item. Item information may then be posted 612 in the purchase field of a web page of the subscriber.

In one embodiment, the generation module 126 may generate a message to the initial subscriber that the purchase of the item has been qualified. The initial subscriber may click a post link in order to post 612 the qualified item on a personal web page assigned to the initial subscriber.

In one configuration, the initial subscriber may click an assignment link to assign the qualified purchase to another subscriber. For example, the initial subscriber may click on the assignment link if a well known subscriber (e.g., athlete, celebrity, or other public figure) might be able to generate more associate subscriber qualified purchases than the original initial subscriber. In one embodiment, the proposed assignee subscriber may receive a message that an assignment for a qualified purchase is pending. The message may include the assignee, the item, the bounty associated with the item, the location of purchase, the purchase price, and the proposed split of the bounty between the original initial subscriber and the assignee subscriber. The proposed assignee may click a link within the message to either accept or reject the assignment. If accepted, the assignee may now become the initial subscriber and the original subscriber cannot be the initial subscriber for that particular qualified purchase. A portion of a bounty associated with the item may be distributed to the assignee and to the original initial subscriber, depending on the agreement between the assignee and the original initial subscriber.

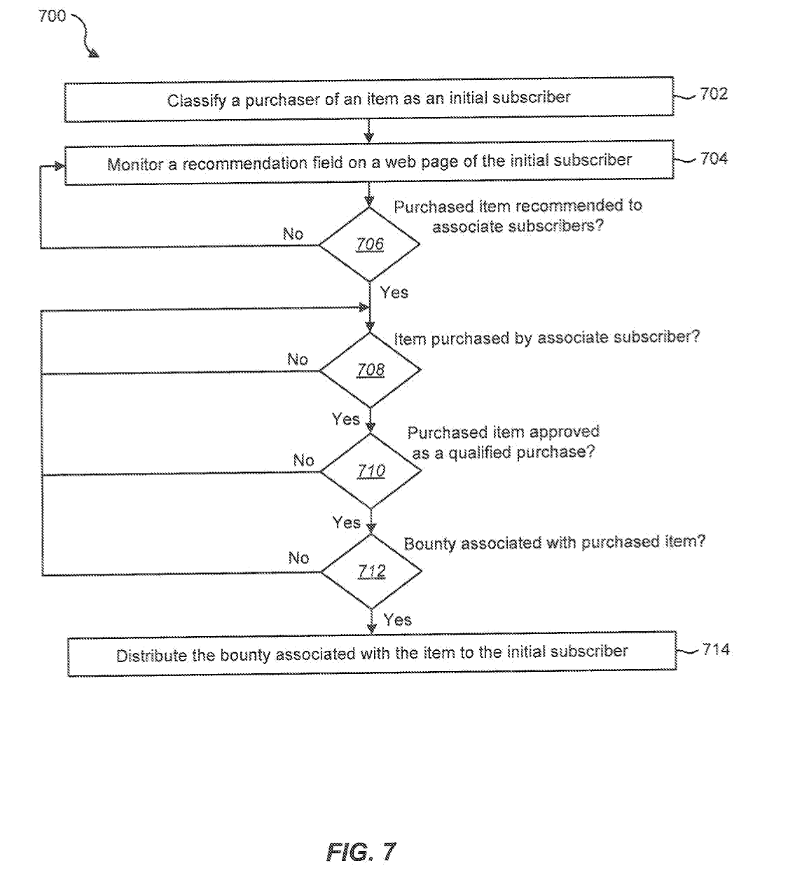

FIG. 7 is a flow diagram illustrating one embodiment of a method 700 for distributing a bounty associated with an item to an initial subscriber. The method 700 may be implemented by the website 106 and the various modules associated with the website 106.

In one embodiment, a purchaser of an item may be classified 702 as an initial subscriber as previously described. A recommendation field on a web page of the initial subscriber may be monitored 704. In order to receive a bounty that is associated with an item, the initial subscriber may be required to recommend the item to at least one associate subscriber. This can be accomplished by posting a recommendation on a web page of the initial subscriber and confirming an associate subscriber viewed the recommendation, or sending a message to the associate subscriber with the recommendation from the website 106. In one embodiment, the message may be sent in any of the manners previously described.

The website 106 may electronically capture and store in the database 128 each associate subscriber who has received a recommendation via a message or who has viewed the recommendation field 216 of a web page assigned to the initial subscriber that includes the recommendation for the item. The generation module 126 may electronically create a list of recommendations of items that have been properly received by an associate subscriber. This may be referred to as a qualification list of items. The qualification list of items may be displayed in the recommendation field 116 of a web page assigned to the initial subscriber. The generation module 126 may also electronically create a list of items that the initial subscriber has recommended to associate subscribers. This list may be referred to as a referral list. This list may also be displayed in the recommendation field 116 of a web page assigned to the initial subscriber.

In one embodiment, a determination 706 may be made as to whether a purchased item has been recommended to associate subscribers. If it is determined 706 that the purchased item has not been recommended to associate subscribers, the method 700 may return to monitor 704 the recommendation field 116 on a web page of the initial subscriber. If, however, it is determined 706 that the purchased item has been recommended to associate subscribers, a determination 708 may then be made as to whether the item was purchased by an associate subscriber. If it is determined 708 that the item has not been purchased by an associate subscriber, the method 700 may continue to determine when a recommended item has been purchased by an associate subscriber. If, however, it is determined 708 that an item is purchased by an associate subscriber, a determination 710 may then be made as to whether the purchase item is approved as a qualified purchase. The purchase may be confirmed as a qualified purchase in a manner similar to that described above. If it is determined 710 that the purchased item is not approved as a qualified purchase, the method 700 may return to determine when a different item is purchased by an associate subscriber. If, however, it is determined that the purchased item is approved as a qualified purchase, a determination 712 may then be made as to whether a bounty is associated with the purchased item. If it is determined 712 that a bounty is not associated with the purchased item, the method 700 may return to determine when a different is purchased by an associate subscriber. If, however, it is determined 712 that a bounty is associated with the purchased item, the bounty associated with the item may be distributed 714 to the initial subscriber.

An associate subscriber who has purchased a item for which he/she received a recommendation from an initial subscriber may further recommend the item to his/her associate subscribers. The associate subscriber, however, may not be classified as an initial subscriber and receive a bounty if/when his/her associate subscribers purchase the recommended item. The original initial subscriber may, however, receive a bounty for each associate subscriber for whom he/she recommends the item if the associate subscriber makes a qualified purchase of the item.

In one example, the generation module 126 of the website 106 may generate customized reports to vendors regarding qualified purchases of items that are linked to a bounty. These reports may include demographic information regarding the purchaser, the retailer, the retail price, the manner of payment, and other information regarding the purchaser and his/her associate subscribers. These reports may allow the vendor to confirm that its advertising dollars resulted in actual revenue, and may also eliminate the need for the vendor to purchase, or prepare its own, demographic information regarding its customers. The present systems and methods thus allow the vendors to better market their products and services by combining a loyalty rewards program with a social networking website.

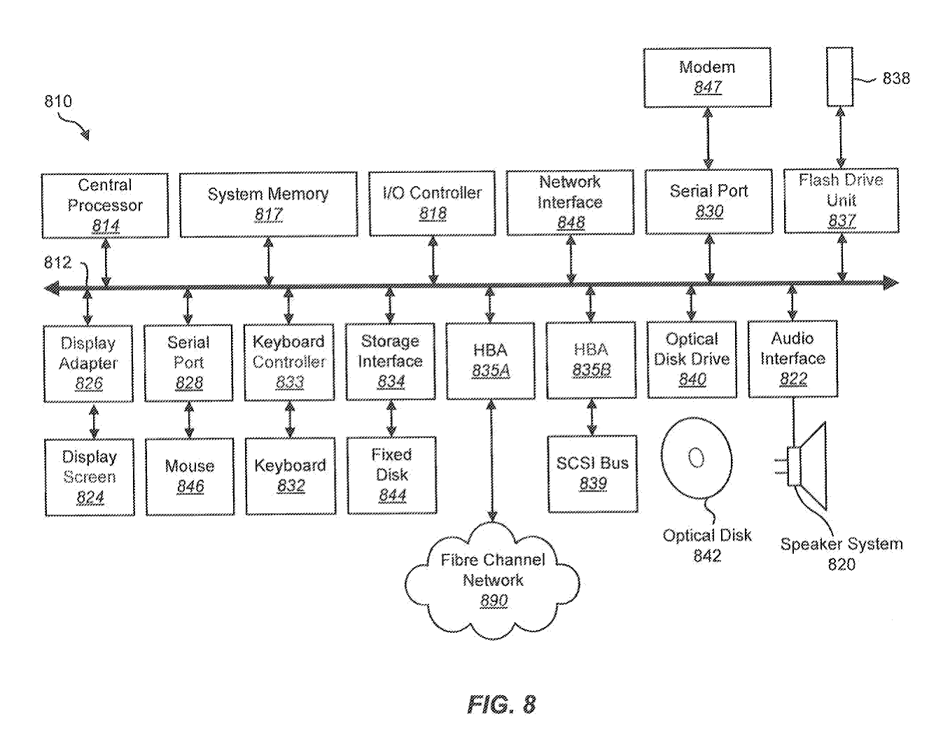

FIG. 8 depicts a block diagram of a computer system 810 suitable for implementing the present systems and methods. Computer system 810 includes a bus 812 which interconnects major subsystems of computer system 810, such as a central processor 814, a system memory 817 (typically RAM, but which may also include ROM, flash RAM, or the like), an input/output controller 818, an external audio device, such as a speaker system 820 via an audio output interface 822, an external device, such as a display screen 824 via display adapter 826, serial ports 828 and 830, a keyboard 832 (interfaced with a keyboard controller 833), a storage interface 834, a flash drive unit 837 operative to receive a flash drive device 838, a host bus adapter (HBA) interface card 835A operative to connect with a Fibre Channel network 890, a host bus adapter (HBA) interface card 835B operative to connect to a SCSI bus 839, and an optical disk drive 840 operative to receive an optical disk 842. Also included are a mouse 846 (or other point-and-click device, coupled to bus 812 via serial port 828), a modem 847 (coupled to bus 812 via serial port 830), and a network interface 848 (coupled directly to bus 812).

Bus 812 allows data communication between central processor 814 and system memory 817, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. Applications resident with computer system 810 are generally stored on and accessed via a computer readable medium, such as a hard disk drive (e.g., fixed disk 844), an optical drive (e.g., optical drive 840), a flash drive unit 837, or other storage medium. Additionally, applications can be in the form of electronic signals modulated in accordance with the application and data communication technology when accessed via network modem 847 or interface 848.

Storage interface 834, as with the other storage interfaces of computer system 810, can connect to a standard computer readable medium for storage and/or retrieval of information, such as a fixed disk drive 844. Fixed disk drive 844 may be a part of computer system 810 or may be separate and accessed through other interface systems. Modem 847 may provide a direct connection to a remote server via a telephone link or to the Internet via an internet service provider (ISP). Network interface 848 may provide a direct connection to a remote server via a direct network link to the Internet via a POP (point of presence). Network interface 848 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 8 need not be present to practice the present systems and methods. The devices and subsystems can be interconnected in different ways from that shown in FIG. 8. The operation of a computer system such as that shown in FIG. 8 is readily known in the art and is not discussed in detail in this application. Code to implement the present disclosure can be stored in computer-readable storage media such as one or more of system memory 817, fixed disk 844, optical disk 842, or flash drive device 838. The operating system provided on computer system 810 may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

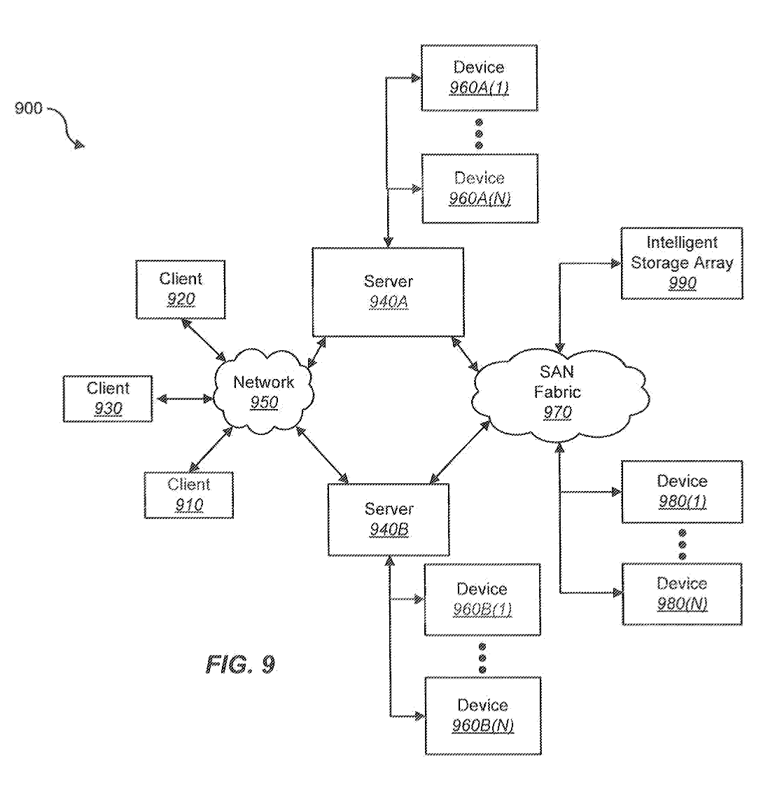

FIG. 9 is a block diagram depicting a network architecture 900 in which client systems 910, 920 and 930, as well as storage servers 940A and 940B (any of which can be implemented using computer system 910), are coupled to a network 950. The storage server 940A is further depicted as having storage devices 960A(1)-(N) directly attached, and storage server 940B is depicted with storage devices 960B(1)-(N) directly attached. SAN fabric 970 supports access to storage devices 980(1)-(N) by storage servers 940A and 940B, and so by client systems 910, 920 and 930 via network 950. Intelligent storage array 990 is also shown as an example of a specific storage device accessible via SAN fabric 970.

With reference to computer system 810, modem 847, network interface 848 or some other method can be used to provide connectivity from each of client computer systems 910, 920 and 930 to network 950. Client systems 910, 920 and 930 are able to access information on storage server 940A or 940B using, for example, a web browser or other client software (not shown). Such a client allows client systems 910, 920 and 930 to access data hosted by storage server 940A or 940B or one of storage devices 960A(1)-(N), 960B(1)-(N), 980(1)-(N) or intelligent storage array 990. FIG. 9 depicts the use of a network such as the Internet for exchanging data, but the present systems and methods are not limited to the Internet or any particular network-based environment.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of” In addition, for ease of use, the words “including” and “having,” as used in the specification and claims, are interchangeable with and have the same meaning as the word “comprising.”

What is claimed is:

1. A computer-implemented method for providing a referral reward incentive via a networking website, comprising:
receiving registration information for an item that is associated with a reward;
displaying information relating to an item purchased by a first subscriber of the networking website;
posting a recommendation for the purchased item from the first subscriber to a second subscriber of the networking website; and
distributing the reward to the first subscriber if the second subscriber purchases the item based on the recommendation received from the first subscriber.

2. The method of claim 1, further comprising confirming whether the purchase of the item by the first subscriber is a qualified purchase.

3. The method of claim 1, further comprising verifying whether the first subscriber received a recommendation for the item prior to the purchase of the item.

4. The method of claim 3, further comprising preventing the distribution of the reward if the first subscriber received a recommendation for the item prior to the purchase of the item.

5. The method of claim 1, further comprising validating login credentials of the first subscriber and the second subscriber for the networking website.

6. The method of claim 5, further comprising generating a first user profile for the first subscriber and a second user profile for the second subscriber.

7. The method of claim 6, further comprising confirming that the first user profile and the second user profile are linked together on the networking website.

8. The method of claim 1, further comprising distributing a first portion of the reward to the first subscriber and a second portion of the reward to a third subscriber, wherein the third subscriber is an assignee of a portion of the reward.

9. The method of claim 1, further comprising posting a recommendation for the purchased item on a web page of the networking website, wherein the web page is assigned to the second user.

10. A computer system configured to provide a referral reward incentive via a networking website, comprising:
a processor;
memory in electronic communication with the processor;
a registration module configured to receive registration information for an item that is associated with a reward;
a purchase field configured to display information relating to an item purchased by a first subscriber of the networking website;
a recommendation field configured to post a recommendation for the purchased item from the first subscriber to a second subscriber of the networking website; and
a distribution module configured to distribute the reward to the first subscriber if the second subscriber purchases the item based on the recommendation received from the first subscriber.

11. The computer system of claim 10, further comprising a confirming module configured to confirm whether the purchase of the item by the first subscriber is a qualified purchase.

12. The computer system of claim 10, further comprising a confirming module configured to verify whether the first subscriber received a recommendation for the item prior to the purchase of the item.

13. The computer system of claim 12, wherein the distribution module is further configured to prevent the distribution of the reward if the first subscriber received a recommendation for the item prior to the purchase of the item.

14. The computer system of claim 10, wherein the registration module is further configured to validate login credentials of the first subscriber and the second subscriber for the networking website.

15. The computer system of claim 14, further comprising a generation module configured to generate a first user profile for the first subscriber and a second user profile for the second subscriber.

16. The computer system of claim 15, further comprising a confirmation module configured to confirm that the first user profile and the second user profile are linked together on the networking website.

17. The computer system of claim 10, wherein the distribution module is further configured to distribute a first portion of the reward to the first subscriber and a second portion of the reward to a third subscriber, wherein the third subscriber is an assignee of a portion of the reward.

18. The computer system of claim 10, wherein the recommendation field is further configured to post a recommendation for the purchased item on a web page of the networking website, wherein the web page is assigned to the second user.

19. A computer-program product for providing a referral reward incentive via a networking website, the computer-program product comprising a computer-readable medium having instructions thereon, the instructions comprising:
code programmed to receive registration information for an item that is associated with a reward;
code programmed to display information relating to an item purchased by a first subscriber of the networking website;
code programmed to post a recommendation for the purchased item from the first subscriber to a second subscriber of the networking website; and
code programmed to distribute the reward to the first subscriber if the second subscriber purchases the item based on the recommendation received from the first subscriber.

20. The computer-program product of claim 19, wherein the instructions further comprise code programmed to confirm whether the purchase of the item by the first subscriber is a qualified purchase.
